(19) United States
(12) Patent Application Publication
(10) Pub. No.: US 2023/0043637 A1
(43) Pub. Date: Feb. 9, 2023

(54) CONTROL DEVICE, CONTROL METHOD AND COMPUTER-READABLE STORAGE MEDIUM

(71) Applicant: NEC Corporation, Minato-ku, Tokyo (JP)

(72) Inventor: Alexander VIEHWEIDER, Tokyo (JP)

(73) Assignee: NEC Corporation, Minato-ku, Tokyo (JP)

(21) Appl. No.: 17/790,239

(22) PCT Filed: Jan. 14, 2020
(86) PCT No.: PCT/JP2020/000816

§ 371 Date: Jun. 30, 2022

(51) Int. Cl. G06F 3/01; B25J 9/16

(52) U.S. Cl. CPC G06F 3/017; B25J 9/163; B25J 9/08

(57) ABSTRACT

A control device 1B includes a preprocessor 21B, a translator 22B and an intention detector 23B. The preprocessor 21B is configured to generate movement signals of a target human 10C subjected to assistance by processing a detection signal Sd outputted by a first sensor which senses the target human 10C. The translator 21B is configured to identify a gesture of the target human 10C by use of the movement signals Sd, the gesture being expressed by a pose and/or movement of the target human 10C. The intention detector 23B is configured to detect an intention of the target human 10C based on history of an event and the identified gesture, the event relating to the assistance.

### TECHNICAL FIELD

The present invention relates to a control device, a control method and a computer-readable for assistance.

### BACKGROUND ART

As we notice the trend to adapt technical systems better to human needs, there is proposed a system which interprets intention of a person by detecting the behavior of the person. For example, PL 1 discloses a system which determines intention of a user based on the latest action of the user and executes a process based on the intention of the user. PL2 discloses an inference system which determines the intension based on an intention knowledge base and which updates the intention knowledge base based on the feedback on the action that is determined by the intension.

### CITATION LIST

### Patent Literature

[PL 1] Japanese Patent Application Laid-open under No. 2019-079204
[PL 2] Japanese Patent Application Laid-open under No. 2005-100390

### SUMMARY OF INVENTION

### Technical Problem

There are tasks where humans need their full attention for carrying out the task itself while reducing instruction effort for a supporting robot or machine to a minimum. Both of PL1 and PL2 are silent on the above issue. This application asks for a special solution which require better sensitive and processing functionality which is the core of this application.

One example of an object of the present invention is to provide a control device, a control method and a computer-readable medium capable of suitably detecting human intention.

### Solution to Problem

As one mode of a control device, there is provided a control device including:

a preprocessor configured to generate movement signals of a target human subjected to assistance by processing a detection signal outputted by a first sensor which senses the target human;

a translator configured to identify a gesture of the target human by use of the movement signals, the gesture being expressed by a pose and/or movement of the target human; and

an intention detector configured to detect an intention of the target human based on history of an event and the identified gesture, the event relating to the assistance.

As one mode of a control method, there is provided a control method including:

generating movement signals of a target human subjected to assistance by processing a detection signal outputted by a first sensor which senses the target human;

identifying a gesture of the target human by use of the movement signals, the gesture being expressed by a pose and/or movement of the target human; and

detecting an intention of the target human based on history of an event and the identified gesture, the event(s) relating to the assistance.

As one mode of a computer-readable storage medium, there is provided a non-transitory computer-readable storage medium storing instructions that, when executed by a processor, cause the processor to:

generating movement signals of a target human subjected to assistance by processing a detection signal outputted by a first sensor which senses the target human;

identifying a gesture of the target human by use of the movement signals, the gesture being expressed by a pose and/or movement of the target human; and

detecting an intention of the target human based on history of an event and the identified gesture, the event relating to the assistance.

### Advantageous Effect of Invention

According to the invention, it is possible to suitably detect human intention thereby to provide a required operational support.

### BRIEF DESCRIPTION OF DRAWINGS

FIG. 1 is a block diagram schematically illustrating a configuration of an assistance system according to a first example embodiment of the invention.

FIG. 2 illustrates a functional block diagram of the processor according to the first example embodiment.

FIG. 3 schematically illustrates a relation among the process executed by the above functional elements of the processor shown in FIG. 2.

FIG. 4 schematically illustrates an example of the data format of the history information.

FIG. 5 illustrates a first application example regarding an object moving task in a storehouse environment.

FIG. 6 illustrates the first application example after a platform robot approaches the place for support.

FIG. 7 illustrates a second application example regarding assistance for fire fighters when fire occurs.

FIG. 8 indicates an example of a flowchart indicative of the process executed by the control device.

FIG. 9 illustrates an assistance system according to the second example embodiment.

FIG. 10 illustrates a control device according to the third example embodiment.

### DESCRIPTION OF EMBODIMENTS

### First Embodiment

### (1) System Configuration

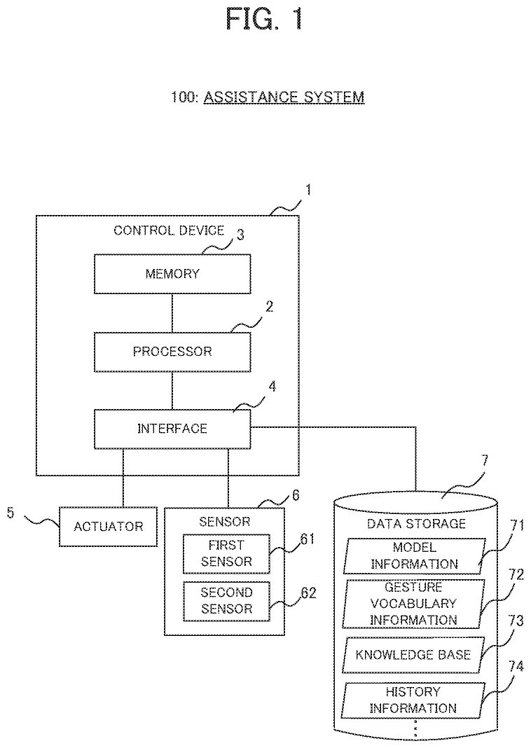

FIG. 1 is a block diagram schematically illustrating a configuration of an assistance system 100 according to a first example embodiment of the invention. The assistance system 100 is a system for comprehension of required operational support based on a detected gesture, events and situation. As illustrated, the assistance system 100 includes a control device 1, actuators 5, sensors 6 and a data storage 7.

The control device 1 controls the actuators 5 based on detection signals outputted by the sensors 6 and data stored in the data storage 7. For example, on the basis of intention inferred from time series behaviors of human(s) and environment, the control device 1 controls a robot which assists a task such as an intervention task (police, fire brigade, . . . ), a maintenance task and an object moving task. It is noted that a target object (referred to as “target control object”) controlled by the control device 1 is not limited to a robot and the target control object may be an electronic product such as a light device which adjusts the brightness of a room.

The control device 1 includes a processor 2, a memory 3 and an interface 4.

The processor 2 is one or more processors such as a CPU (Central Processing Unit) and a GPU (Graphics Processing Unit) and executes various processing necessary for the control device 1. The processor 2 executes a program preliminarily stored in the memory 3 or the data storage 7 thereby to achieve the various processing. The memory 3 typically includes a ROM (Read Only Memory) and a RAM (Random Access Memory), and stores necessary programs to be executed by the processor 2. The memory 3 also serves as a work memory during execution of various processing by the processor 2.

The interface 4 executes the interface operation with external devices such as the actuators 5, the sensors 6 and the data storage 7. For example, the interface 4 provides the processor 2 with detection signals outputted by sensors 6 and data extracted from the data storage 7. The interface 4 also provides the actuators 5 with control signals generated by the processor 2 and provides the data storage 7 with updating data generated by the processor 2.

The actuators 5 are drive mechanism of the target control object and driven based on control signals supplied from the control device 1.

The sensors 6 are sensors needed for the control device 1 to control the target control object. The sensors 6 includes a first sensor 61 that is one or more sensor provided at the target control object and a second sensor 62 that is one or more sensor capable of sensing the overall field (referred to as “target field”) where the target control object exists and deals with a task. Examples of the first sensor 61 and the second sensor 62 include an imaging device such as a camera and a depth sensor such as a lidar (Light Detection and Ranging or Laser Imaging Detection and Ranging). The sensors 6 supplies detection signals to the control device 1.

The data storage 7 includes a non-volatile memory needed for the control device 1 to perform various processes. The data storage 7 includes model information 71, gesture vocabulary information 72, knowledge base 73 and history information 74.

The model information 71 is information associated with a model that can have different shapes for determining an action of the target control object. The model information 71 is used for the control device 1 to estimate the influence of user's intervention and to determine the operation mode of the target control object. The model information 71 is prepared in advance in consideration of the dynamics of the target control object, the environment and the task to be performed by the target control object. The model information 71 may include parameters used for each operation mode of the target control object. The model information 71 may be updated based on a user feedback on the action of the target control object and the environment input.

The gesture vocabulary information 72 indicates the vocabulary of gestures of the target human subjected to assistance by the target control object. For example, gestures that can be identified by the assistance system 100 are determined in advance and the gesture vocabulary information 72 indicates the features (feature parameters) of these gestures to identify each of the gestures. The term “gesture” (generalized gesture) herein indicates not only an explicit gesture for instructing a target control object to assist a task but also an implicit gesture indicative of needing assistance. The gesture is expressed by the pose and the movement of a target human of assistance. It is also noted that for the purpose of this patent it is distinguished between explicit gestures and implicit gesture, where implicit gestures are change dynamics in human body that contain the information of the activity itself.

The knowledge base 73 is information used for the control device 1 to determine intention of the target human or action of the target control object. The knowledge base 73 may include a look-up table or a map which maps each pattern of time-series behaviors of the target human and environment to each corresponding intention to be inferred. The knowledge base 73 can updated also based on a user feedback that is a negative response by the target human on the action of the target control object during the time the target control object is controlled by using an estimated intention. Note that the knowledge base 73 is used for intention detection and optimization.

The history information 74 indicates the history of three types of elements: gesture, event and situation. The gesture herein indicates the detected gesture(s) of the target human subjected to assistance, the event herein indicates the detected event(s) associated with the assistance, and the situation herein indicates the detected situation(s) of the assistance. A description will be given of the detailed data format of the history information 74.

### (2) Block Diagram

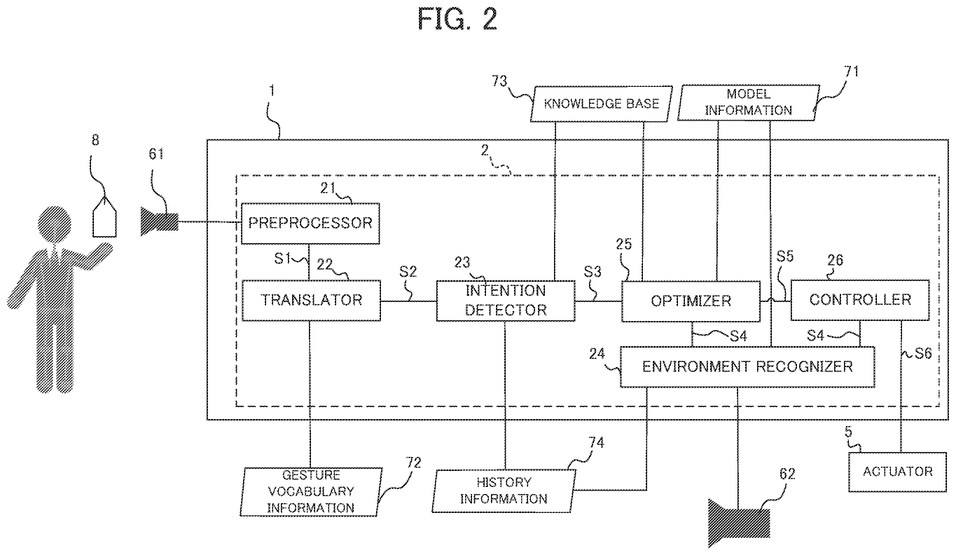

FIG. 2 illustrates a functional block diagram of the processor 2. The process functionally includes a preprocessor 21, a translator 22, an intention detector 23, an environment recognizer 24, an optimizer 25 and a controller 26.

The preprocessor 21 generates movement signals (dynamic signals) “S1” of a target human subjected to assistance by processing time-series detection signals outputted by the first sensor 61 (e.g., camera) which senses the target human. For example, the preprocessor 21 detects the position of specific joints of the target human as virtual points from an image outputted by the first sensor 61 and tracks each of virtual points through images outputted in sequences by the first sensor 61. Since various kinds of approaches for generating movement signals of joints of a human based on time-series images are already proposed, the detailed explanation thereof will be skipped herein. The preprocessor 21 supplies the movement signals S1 to the translator 22. It is also noted that the preprocessor 21 may have also the additional functionality of detecting object(s) 8 in the vicinity of the target human subjected to assistance in addition to the ability to detect people in the image outputted by the first sensor 61. In this case, the preprocessor 21 further generates movement signals of the object(s) 8 in a vicinity of the target human in addition to the movement signals of the target human.

The translator 22 identifies a gesture of the target human by use of the movement signals with reference to the gesture vocabulary information 72. The gesture vocabulary information 72 indicates vocabulary of gestures which can be identified by the assistance system 100. For example, the gesture vocabulary information 72 indicates movement information of joints of a human with respect to each of the gestures. Thus, by cross-checking the movement signals S1 with the gesture vocabulary information 72, the translator 22 identifies the gesture performed by the target human. Then, the translator 22 supplies gesture information “S2” indicative of the detected gesture to the intention detector 23. It is noted that gesture vocabulary information 72 may be parameters to configure a classifier which identifies the gesture based on the movement signals S1. In this case, parameters are generated in advance through machine learning such as deep learning and support vector machine. Classifiers labels could be “raising left/right arm, the hand”, etc.

In the case that the preprocessor 21 has also the additional functionality of detecting object(s) 8 in the vicinity of the target human subjected to assistance, the translator 22 derives a relationship parameter between the target human and the object(s) 8 by calculating correlation between the movement of the target human and the movement of the objects(s) 8. Thereby, the translator 22 obtains information relating to the relationship parameter for further processing by the translator 22. For example, in cases that an object 8 exists, the translator 22 recognizes the gesture description classification “G15” indicative of “raises left/right arm-relationship-with holding-object” instead of the implicit gesture classification “G1” indicative of “raises arm”. As described above, on the basis of the movement signals of the target human and the movement signals of the object, the translator 22 identifies a gesture of the target human associated with the object(s) 8.

The intention detector 23 detects the intention of the target human based on the gesture information S2. First, the intention detector 23 updates the history information 74 based on the gesture information S2. Then, with reference to the history information 74, the intention detector 23 detects the intention of the target human. For example, with reference to a look-up table (map) which maps each possible combination of gesture(s), event(s) and situation to each appropriate intention, the intention detector 23 may determine the intention based on the history information 74. The above look-up table is prepared and memorized in the data storage 7 as the knowledge base 73 or in the memory 3 in advance. It is noted that gesture vocabulary information 72 may be parameters to configure a classifier which identifies the gesture based on the movement signals S1. In this case, parameters are generated in advance through machine learning such as deep learning and support vector machine.

Since the history information 74 indicates the historical unfolding of one of more events and one or more gestures in each detected situation, the intention detector 23 can determine the intention in comprehensive consideration of the situational context, unfolding of events(context) and the action of the target human subjected to assistance. The intention detector 23 supplies intention information “S3” indicative of the detected intention to the optimizer 25.

Additionally, if the intention detector 23 detects a gesture indicative of a feedback on the action of the target control object, the intention detector 23 updates the knowledge base 73. Examples of the gesture indicative of a feedback include a gesture indicative of refusal of the action performed by the target control object and other negative gestures against the action performed by the target control object. For example, the intention detector 23 updates the knowledge base 73 based on information of the action refused by the target human and the sequence of event, situation and gesture which was used to determine the above action. Thereafter, the intention detector 23 determines the intention of the target human based on the knowledge base 73 in which the feedback is reflected. Thereby, the control device 1 can prevent the target control object from taking the refused action in the same condition.

On the basis of detection signals outputted by the second sensor 62, the environment recognizer 24 recognizes the environment in the target field where the target control object performs the assistance. For example, when an event associated with the assistance occurs or the situation in the target field changes, the environment recognizer 24 recognizes the event or the changed situation. Then, the environment recognizer 24 records the event or the situation in the history information 74. For example, events and situations which the environment recognizer 24 should recognize are predetermined and information needed to recognize each of the events and the situations are stored in the data storage 7 in advance.

Furthermore, the environment recognizer 24 supplies the recognized environment information “S4” to the optimizer 25 and the controller 26. Examples of the environment information S4 include information relating to obstacles near the target control object, information relating to a package that the target control object should carry, information relating to a broken part that the target control object should fix, information relating to fire that the target control object should put out. The environment recognizer 24 has also the ability to update the model information 71. This is especially important in a fast-changing environment. For example, if the model describes how the phenomenon fire evolves, it is necessary to update model or model parameters to keep an accurate as possible understanding of the environment and its evolution for optimization and control purposes of using the robot(s)/machine(s).

On the basis of the intention information S3 and the environment information S4, the optimizer 25 determines the action that the target control object should take. In this case, the optimizer 25 determines the action with reference to the model information 71. The optimizer 25 sporadically changes the operation modes of the target control object in order to find better patterns of the assistance. Generally, if the intention is clear, then optimization and concrete assistance operation can be devised. The optimizer 25 uses a model that can have different shapes indicated by the model information 71 if the optimization is not based on a pure trial and error optimization method. The optimizer 25 also updates the model information 71 based on the feedback information supplied from the intention detector 23 so that the user reaction indicative of feedback on the action of the target control device is reflected to the determination of following actions of the target control object. The optimizer 25 supplies the controller 26 with action information “S5” indicative of the determined action (i.e., plan information) of the target control object.

The controller 26 generates control signals “S6” based on the action information S5 and supplies the control signals S6 to the actuators 5. In this case, the controller 26 generates the control signals S6 so that the target control object takes actions indicated by the action information S5. The controller 26 may generate the control signals S6 in further consideration of the environment information S4 supplied from the environment recognizer 24. Since there are already proposed various approaches for optimization and the operation of a target control object after recognizing the intention, the detailed explanation thereof will be omitted herein.

It is noted that each component of the preprocessor 21, the translator 22, the intention detector 23, the environment recognizer 24, the optimizer 25 and the controller 26 can be realized by the process 2 executing program(s), for example. Specifically, above each component can be realized through execution of program(s) stored in the memory 3 by the process 2. In another example, each component may be realized by installing necessary program(s) stored in any non-volatile memory as necessary. It is also noted that each component is not limited to what is realized by a software program and that each component may be realized by any combination selected from hardware, firmware and software. It is also noted that each component may be realized by use of an integrated circuit which can be programmed by a user such as a FPGA (Field-Programmable Gate Array) and a microcomputer. The above-mentioned explanation can also be applied to other example embodiments to be described later.

### (3) Relation Among Process

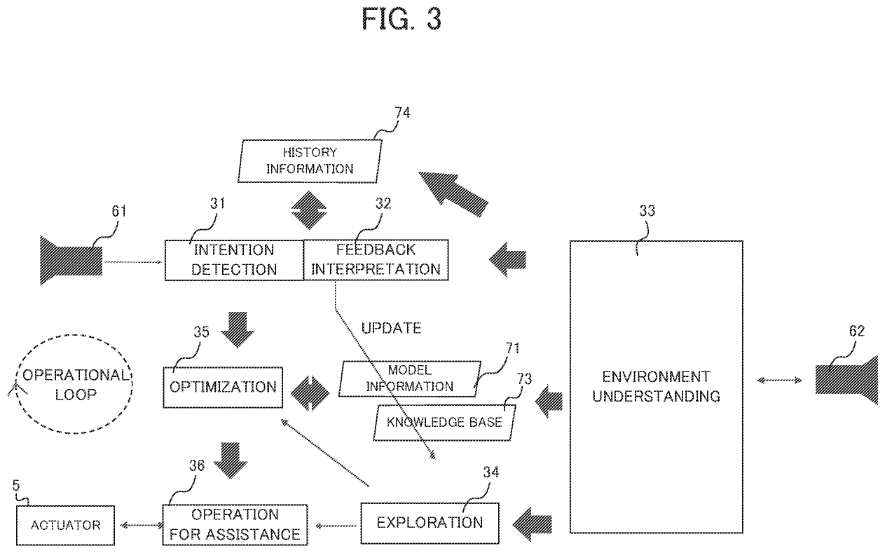

FIG. 3 schematically illustrates a relation among the process executed by the above components of the processor 2 shown in FIG. 2. The processor 2 mainly executes intention detection 31, feedback interpretation 32, environment understanding 33, exploration 34, optimization 35 and operation for assistance 36.

The intention detection 23 is performed based on the detection result by the first sensor 61 while updating and referring to the history information 74. The feedback interpretation 32 is also performed in parallel with the intention detection 31, and the model information 71 and the knowledge base 73 are updated based on the result of the feedback interpretation 32. It is noted that since in most cases from detection signals outputted by sensors 6 intention cannot be inferred directly, a sophisticated module which executes the intention detection 31 and the feedback interpretation 32 is necessary.

The environment understanding 33 is performed based on the detection result by the second sensor 62. The result of the environment understanding 33 is used for the intention detection 31, the feedback interpretation 32, the exploration 34 and updating processes of the model information 71, the knowledge base 73 and the history information 74. Environment understanding 33 also includes detecting events such as new person entering the scene, explosion of object or others.

The Exploration 36 means that sporadically the operation modes of the control device 1 are changed in order to find better patterns of assistance. The optimization 35 is performed on the basis of the results of the intention detection 31 and the exploration 34 and with reference to the model information 71 and the knowledge base 73. On the basis of the result of the exploration 34 and the optimization 35, the operation for assistance 36 to drive the actuators 5 is performed. The above processes are repeatedly executed.

### (4) Data Format

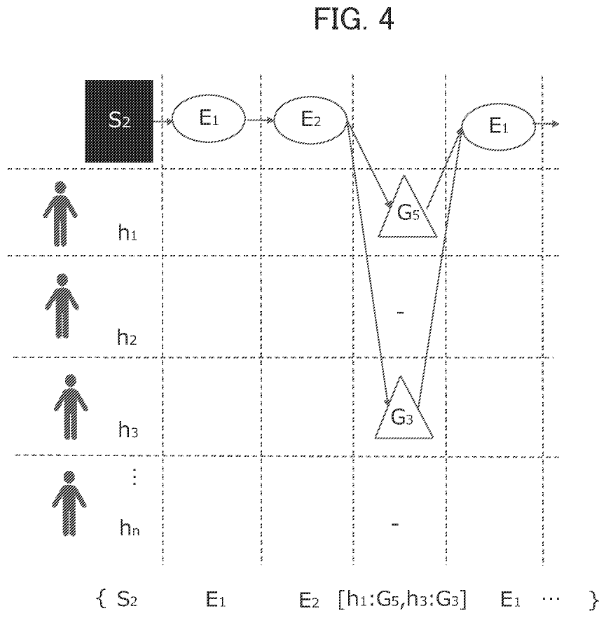

FIG. 4 schematically illustrates an example of the data format of the history information 74. Regarding the history information 74, a compact and efficient description is desirable that can be processed with low effort. According to the first example embodiment, regular expression is applied as the format of the history information 74.

The history information 74 includes a list which has three types of data sets: situation, events and gestures. Hereinafter, “S={S₁, S₂, . . . , Sₗ}” are identification symbols of situations, “E={E₁, E₂, . . . , Eₘ}” are identification symbols of events and “G={G₁, G₂, . . . , Gₙ}” are identification symbols of gestures. “h₁, h₂, h₃, . . . , hₙ” are identification symbols of human beings. Elements of the list may be separated with respect to each situation.

According to FIG. 4, after being in the situation S₂, the control device 1 detects the event E₁ and the event E₂ in sequence. Then, the control device 1 detects the gesture G₅ by the human h₁ and the gesture G₃ by the human h₃ in substantially the same time and thereafter detects the event E₁ again. In this case, the control device 1 adds the following information to the list memorized as the history information 74.

{S₂ E₁ E₂ [h₁:G₅, h₃:G₃] E₁}

Thereby, the control device 1 suitably generates the history information 74 with a compact and efficient description that can be processed with low effort.

### (5) Application Examples

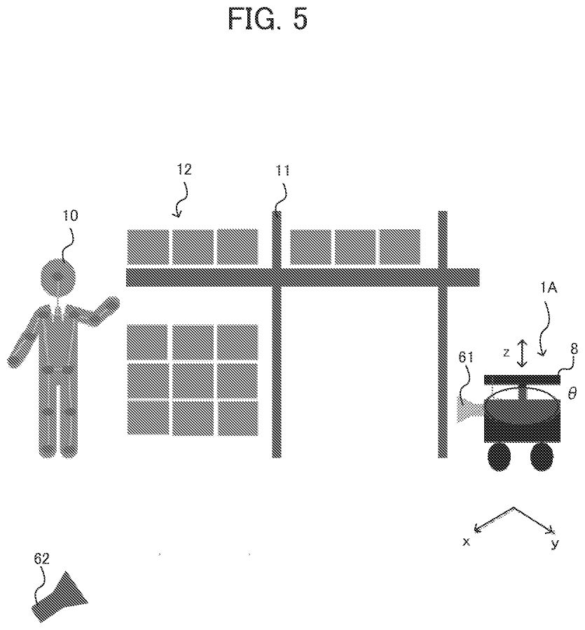

FIG. 5 illustrates a first application example regarding an object moving task in a storehouse environment. In the storehouse, there is a platform robot 1A equipped with a first sensor 61 that is a camera and a platform 8 and there is a worker 10 that is a target human of assistance. The platform robot 1A serves as a target control robot in which the control device 1 is incorporated. The platform robot 1A receives detection signals outputted by the second sensor 62. The platform robot 1A has four degrees of freedom as a mechanical implementation, wherein the platform robot 1A can move along a x-y plane and rotate on its own axis (θ) and change the height z of the platform.

In the situation according to the first application example, the worker 10 wants to move objects 12. The platform robot 1A senses the human 10 in need of the platform 8 through the detection signals outputted by sensors. Then, the platform robot 1A detects his pose and identifies his gesture based on detection signals outputted by the first sensor 61 while detecting events and situations in the storehouse based on detection signals outputted by the second sensor 62. Then, the platform robot 1A detects the intention to lift and move objects 12 stored in a shelf 11 and approaches the place for support.

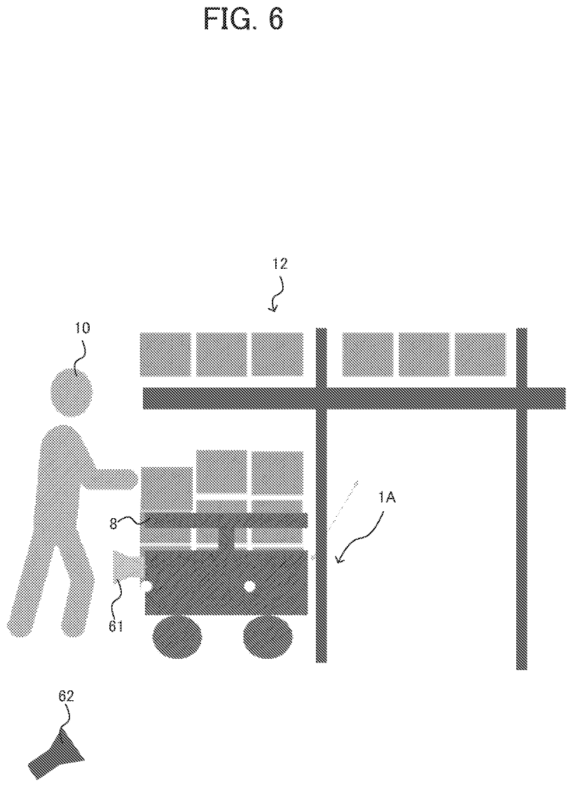

FIG. 6 illustrates the first application example after the platform robot 1A approaches the place for support. In this case, the platform robot 1A provides the platform 8 at the right height and therefore the worker 10 can move objects 12 to the platform 8 easily. When the worker 10 goes to his desired object destination place thereafter, the platform robot 1A detects the intention by interpreting the action of the worker 10 that is a kind of a gesture (generalized gesture) and then follows the worker 10 with the objects 12. The platform robot 1A may stops or goes to a predetermined resting position. In this application example the “Exploration module” which executes the exploration 36 in FIG. 3 would suggest from time to time to assist the worker instead from its usual side (e.g. left) on the other side and the system would evaluate by its sensor if this different type of assistance is welcomed by the worker. For example, the optimizer 25 in FIG. 2 functions as the above exploration module.

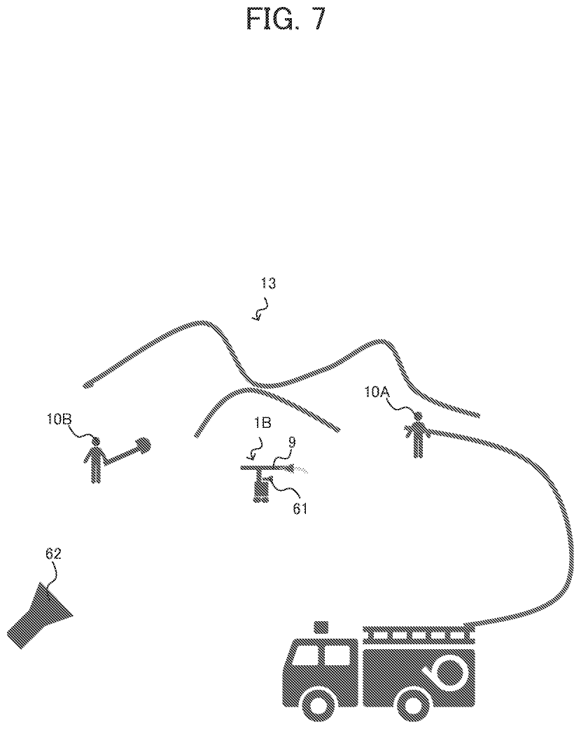

FIG. 7 illustrates a second application example regarding assistance for fire fighters when fire 13 occurs. In this case, a fire fighter 10A is in the middle of putting out the fire 13 and another fire fighter 10B is dealing with other relevant task. A fire fighter robot 1B serves as a target control robot in which the control device 1 is incorporated. The fire fighter robot 1B is equipped with the first sensor 61 and a fire-fighting hose 9. The fire fighter robot 1B receives detection signals outputted by the second sensor 62.

On the basis of detection signals outputted by the first sensor 61 and the second sensor 62, the fire fighter robot 1B detects the situation, each kind of events and gestures (which include any kinds of behaviors) of the fire fighters 10A and 10B. Then, fire fighter robot 1B determines that the fire fighter robot 1B should help the fire fighter 10A put out the fire 13 and fire fighter robot 1B approaches the fire 13 and releases water jet to the fire 13 by use of the fire-fighting hose 9.

For example, on the basis of the detection result, the fire fighter robot 1B generates the history information 74 as follows.

{S₀ E₁ E₂ G₁ . . . }

The identification symbol of situation S₀ indicates a situation that the fire fighter robot 1B arrives at the location of fire 13. The identification symbol of event E₁ indicates an event that one fire fighter (the fire fighter 10A) advances toward the fire 13. The identification symbol of event E₂ indicates an event that one fire fighter (the fire fighter 10B) retreats. The identification symbol of gesture G₁ indicates a gesture that one fire fighter (the fire fighter 10A) points to a specific location for water jet.

In this case, on the basis of the history information 74, the fire fighter robot 1B detects the intention of the fire fighter 10A and determines that the fire fighter robot 1B should take action “A₁” that is an action of release of water jet to the specific location. Instead, the fire fighter robot 1B may determine that the fire fighter robot 1B should take action “A₂” that is an action of helping the fire fighter 10B retreat if the event E₂ is prioritized. If the fire fighter robot 1B detects any feedback gesture indicative of refusal on the action A₁ or the action A₂ of the fire fighter robot 1B from the fire fighter 10A or fire fighter 10B, the fire fighter robot 1B updates the model information 71 and the knowledge base 73 and takes the feedback into account at the time of intention detection and/or optimization to determine the intention and/or actions of the fire fighter robot 1B thereafter.

### (6) Process Flow

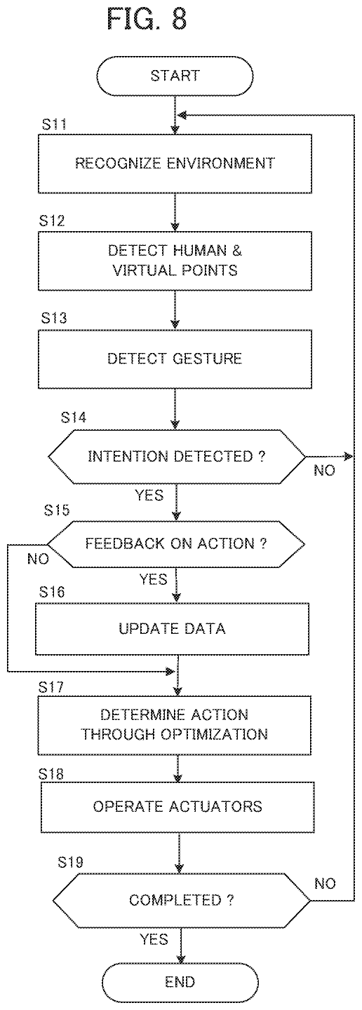

FIG. 8 indicates an example of a flowchart indicative of the process executed by the control device 1.

First, on the basis of detection signals outputted by the sensors 6, the control device 1 recognizes the environment in the target field (step S11). For example, the control device 1 recognizes the current situation and an event that occurs in the target field. The control device 1 records the event and/or situation in the history information 74.

Then, on the basis of the detection signals outputted by the sensors 6, the control device 1 detects one or more target humans subjected to assistance by the target control object and their virtual points (step S12). Thereby, the control device 1 generates the movement signals S1. Then, the control device 1 detects gesture(s) performed by at least one of the target humans (step S13). The control device 1 records information indicative of the gesture(s) in the history information 74.

Next, the control device 1 determines whether or not any intention is detected (step S14). In this case, with reference to the knowledge base 73 and the history information 74, the control device 1 determines whether or not an intention is detected.

If the control device 1 determines that any intention is not detected (step S14; No), the control device 1 goes back to the process at step S11 and keeps monitoring the environment and each target human.

When the control device 1 determines that an intention is detected (step S14; Yes), the control device 1 further determines whether or not there is a feedback on the action of the target control object (step S15). If there is a feedback on the action of the target control object (step S15; Yes), the control device 1 updates data used for intention detection and/or optimization such as the knowledge base 73 and the model information 71 (step S16).

When control device 1 determines that there is no feedback on the action of the target control object (step S15; No) or when the process at step S16 is completed, the control device 1 determines the action of the target control object through optimization (step S17). Then, the control device 1 operates the actuators 5. Thereafter, the control device 1 determines whether or not the assistance by the target control object is completed (step 19). If the control device 1 determines that the assistance is completed (step S19; Yes), the control device 1 terminates the process of the flowchart. Then, for example, the control device 1 drives the target control object to move to a predetermined ready position. It the control device 1 determines that the assistance is not completed (step S19; No), the control device 1 goes back to the process at step S11.

### (7) Effects

A description will be given of the effect according to the first example embodiment.

The assistance system 100 understands human needs and intention for assistance regarding or specific to a certain task based on human intention clues. This understanding is done in a manner that: the understanding is less intrusive as possible; the generalized gesture of the human is interpreted considering history and context (thereby explicit instruction overhead is eliminated); implicit feedback to operation change is evaluated in order to improve the operation of the assistance system 100; and the set of possible actions is determined from observation of the environment. Since the assistance system has model information 71, it can also estimate the influence of user's intervention and determine unknown operation modes which may have advantages. Besides, advantageous data format for history information 74 indicative of sequence of situation, event and gesture is introduced in the first example embodiment.

### Second Example Embodiment

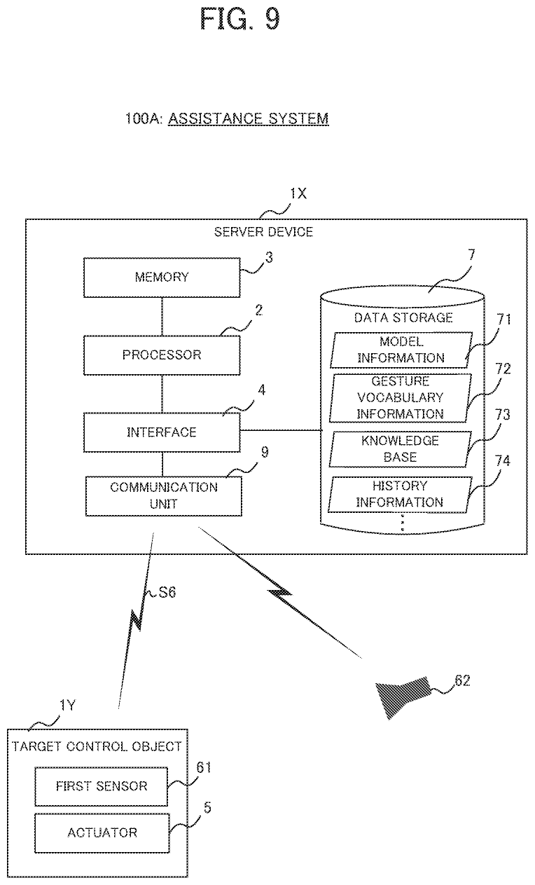

FIG. 9 illustrates an assistance system 100A according to the second example embodiment. The assistance system 100A includes a server device 1X and a target control object 1Y. Hereinafter, the same reference numbers as the first example embodiment are allocated to the same elements as the first example embodiment and the explanation thereof will be omitted.

The server device 1X functions as the control device 1 according to FIG. 1 and performs the intention detection, optimization and control of the target control object 1Y. The server device 1X receives detection signals outputted by the first sensor 61, which is provided at the target control object 1Y, and the second sensor 62. Then, the server device 1X generates control signals S6 and sends the control signals S6 to the target control object 1Y. The server device 1X includes a processor 2, a memory 3, an interface 4, data storage 7 and a communication unit 9. The processor 2, the memory 3, the interface 4 and data storage 7 in the server device 1X correspond to the processor 2, the memory 3, the interface 4 and the data storage 7 in the control device 1 in FIG. 1, respectively. The communication unit 9 sends the control signals S6 to the target control object 1Y under the control of the processor 2. The processor 2 functionally includes the preprocessor 21, the translator 22, the intention detector 23, the environment recognizer 24, the optimizer 25 and the controller 26 illustrated in FIG. 2. It is noted that the server device 1X may be constituted by multiple devices. In this case, each of the multiple devices exchanges data with each other to execute preliminarily-allocated own task.

The target control object 1Y is equipped with the actuators 5 and the first sensor 61 and sends detection signals outputted by the first sensor 61 to the server device 1X. The target control object 1Y receives the control signals S6 and drives the actuators 5 based on the control signals S6.

Even according to the second example embodiment, the server device 1X can detect an intention of a human and drives the target control object 1Y to suitably assist the human.

### Third Example Embodiment

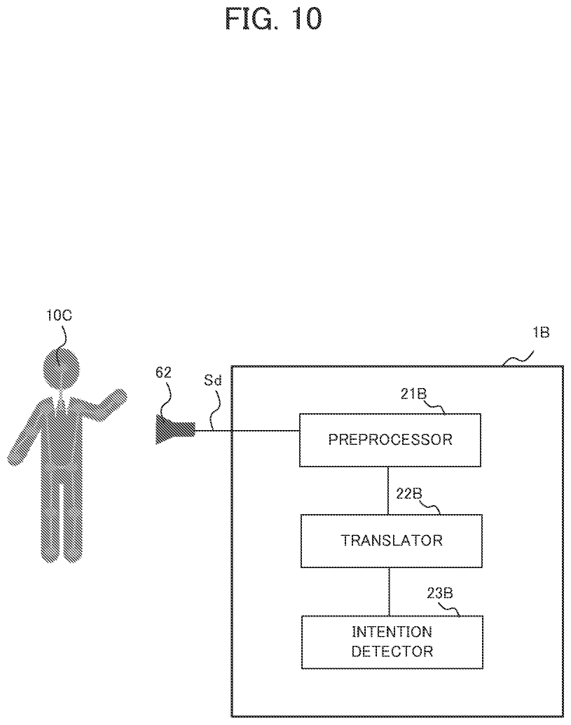

FIG. 10 illustrates a control device 1B according to the third example embodiment. The control device 1B includes a preprocessor 21B, a translator 22B and an intention detector 23B.

The preprocessor 21B is configured to generate movement signals of a target human 10C subjected to assistance by processing a detection signal “Sd” outputted by a first sensor which senses the target human 10C. For example, the preprocessor 21B can be realized by the preprocessor 21 according to the first example embodiment.

The translator 21B is configured to identify a gesture of the target human 10C by use of the movement signals Sd, the gesture being expressed by a pose and/or movement of the target human 10C. For example, the translator 22B can be realized by the translator 22 according to the first example embodiment.

The intention detector 23B is configured to detect an intention of the target human 10C based on history of an event and the identified gesture, the event relating to the assistance. The examples of “history of an event and the identified gesture” includes historical unfolding of one of more events and one or more gestures in the detected situation indicated by the history information 74 according to the first example embodiment. For example, the intention detector 23B can be realized by the intention detector 23 according to the first example embodiment.

According to the third example embodiment, the fire fighter robot 1B can suitably detect the intention of the target human subjected to the assistance in consideration of the history of an event and a gesture associated with the assistance.

For the above-mentioned example embodiments, a program can be stored on any one of various types of non-transitory computer readable media and be supplied to the processor 2 that is a computer. Examples of a non-transitory computer readable media include various types of tangible storage media. Examples of the non-transitory computer readable media include: a magnetic recording medium such as a flexible disc, a magnetic tape and a hard drive; a magneto-optical recording medium such as a magneto-optical disk; a CD-ROM; a CD-R; a CD-R/W; and a semiconductor memory such as a mask ROM, a PROM (Programmable ROM), an EPROM (Erasable PROM), a flash ROM and RAM. The above program may be supplied to the computer through any one of various types of transitory computer readable media. Examples of a transitory computer readable media include an electric signal, a light signal and an electromagnetic ray. The transitory computer readable media can supply the program to the computer via an electric wire, a wired communication path and/or a wireless communication path.

The above-described example embodiments can be partially or entirely expressed by, but is not limited to, the following Supplementary Notes.

### (Supplementary Note 1)

A control device including:

a preprocessor configured to generate movement signals of a target human subjected to assistance by processing a detection signal outputted by a first sensor which senses the target human;

a translator configured to identify a gesture of the target human by use of the movement signals, the gesture being expressed by a pose and/or movement of the target human;

an intention detector configured to detect an intention of the target human based on history of an event and the identified gesture, the event relating to the assistance.

### (Supplementary Note 2)

The control device according to Supplementary Note 1, further including

an environment recognizer configured to recognize the event and a situation of the assistance based on a detection signal outputted by a second sensor which senses the environment,

wherein the intention detector detects the intention based on the history of the situation, event and gesture.

### (Supplementary Note 3)

The control device according to Supplementary Note 2,

wherein the history is recorded by use of a data format according to a regular expression having three types of data sets of the situation, event and gesture.

### (Supplementary Note 4)

The control device according to Supplementary Note 1, further including

an optimizer configured to determine, on the basis of the detected intention, an action of a target control object subjected to control by the control device, and

a controller configured to control the target control object based on the determined action.

### (Supplementary Note 5)

The control device according to Supplementary Note 4,

wherein the intention detector detects a feedback regarding the action of the target control object and

wherein the optimizer changes operation modes for operating the target control object through the feedback.

### (Supplementary Note 6)

The control device according to Supplementary Note 4,

wherein the intention detector detects the intention based on knowledge base, and

wherein, at a time of detecting a feedback regarding the action of the target control object, the intention detector updates the knowledge base based on the feedback.

### (Supplementary Note 7)

The control device according to Supplementary Note 1,

wherein the preprocessor further generates movement signals of an object in a vicinity of the target human, and

wherein, on a basis of the movement signals of the target human and the movement signals of the object, the translator identifies a gesture of the target human associated with the object.

### (Supplementary Note 8)

The control device according to Supplementary Note 1,

wherein the target control object is a robot which acts according to a control signal generated by the control device, and

wherein the control device is incorporated into the robot.

### (Supplementary Note 9)

The control device according to Supplementary Note 1,

wherein the target control object is a robot which acts according to a control signal generated by the control device and

wherein the control device is a server device which sends the control signal to the robot.

### (Supplementary Note 10)

A control method including:

generating movement signals of a target human subjected to assistance by processing a detection signal outputted by a first sensor which senses the target human;

identifying a gesture of the target human by use of the movement signals, the gesture being expressed by a pose and/or movement of the target human;

detecting an intention of the target human based on history of an event and the identified gesture, the event relating to the assistance.

### (Supplementary Note 11)

A non-transitory computer-readable storage medium storing instructions that, when executed by a processor, cause the processor to:

generating movement signals of a target human subjected to assistance by processing a detection signal outputted by a first sensor which senses the target human;

identifying a gesture of the target human by use of the movement signals, the gesture being expressed by a pose and/or movement of the target human; and

detecting an intention of the target human based on history of an event and the identified gesture, the event relating to the assistance.

While the invention has been particularly shown and described with reference to example embodiments thereof, the invention is not limited to these embodiments. It will be understood by those of ordinary skilled in the art that various changes in form and details may be made therein without departing from the spirit and scope of the present invention as defined by the claims. All patent literatures mentioned in this specification are incorporated by reference in its entirety.

### INDUSTRIAL APPLICABILITY

This invention can be used for robotics, assistance systems, collaborative robots, electronic products and a controller such as a server device which controls them.

### REFERENCE SIGN LIST

1 Control device
1A Platform robot
1B Fire fighter robot
1X Server device
1Y Target control object
2 Processor
3 Memory
4 Interface
5 Actuator
6 Sensor
7 Data storage
9 Communication unit

1. A control device comprising:
a preprocessor configured to generate movement signals of a target human subjected to assistance by processing a detection signal outputted by a first sensor which senses the target human;
a translator configured to identify a gesture of the target human by use of the movement signals, the gesture being expressed by a pose and/or movement of the target human;
an intention detector configured to detect an intention of the target human based on history of an event and the identified gesture, the event relating to the assistance.

2. The control device according to claim 1, further comprising
an environment recognizer configured to recognize the event and a situation of the assistance based on a detection signal outputted by a second sensor which senses the environment,
wherein the intention detector detects the intention based on the history of the situation, event and gesture.

3. The control device according to claim 2,
wherein the history is recorded by use of a data format according to a regular expression having three types of data sets of the situation, event and gesture.

4. The control device according to claim 1, further comprising
an optimizer configured to determine, on the basis of the detected intention, an action of a target control object subjected to control by the control device, and
a controller configured to control the target control object based on the determined action.

5. The control device according to claim 4,
wherein the intention detector detects a feedback regarding the action of the target control object and
wherein the optimizer changes operation modes for operating the target control object through the feedback.

6. The control device according to claim 4,
wherein the intention detector detects the intention based on knowledge base, and
wherein, at a time of detecting a feedback regarding the action of the target control object, the intention detector updates the knowledge base based on the feedback.

7. The control device according to claim 1,
wherein the preprocessor further generates movement signals of an object in a vicinity of the target human, and
wherein, on a basis of the movement signals of the target human and the movement signals of the object, the translator identifies a gesture of the target human associated with the object.

8. The control device according to claim 1,
wherein the target control object is a robot which acts according to a control signal generated by the control device and
wherein the control device is incorporated into the robot.

9. The control device according to claim 1,
wherein the target control object is a robot which acts according to a control signal generated by the control device and
wherein the control device is a server device which sends the control signal to the robot.

10. A control method comprising:
generating movement signals of a target human subjected to assistance by processing a detection signal outputted by a first sensor which senses the target human;
identifying a gesture of the target human by use of the movement signals, the gesture being expressed by a pose and/or movement of the target human; and
detecting an intention of the target human based on history of an event and the identified gesture, the event relating to the assistance.

11. A non-transitory computer-readable storage medium storing instructions that, when executed by a processor, cause the processor to:
generating movement signals of a target human subjected to assistance by processing a detection signal outputted by a first sensor which senses the target human;
identifying a gesture of the target human by use of the movement signals, the gesture being expressed by a pose and/or movement of the target human; and
detecting an intention of the target human based on history of an event and the identified gesture, the event relating to the assistance.
